(19) United States
(12) Patent Application Publication
(10) Pub. No.: US 2023/0367489 A1
(43) Pub. Date: Nov. 16, 2023

(54) PERFORMING CRYPTOGRAPHIC FUNCTIONS AT A MEMORY SYSTEM

(71) Applicant: Micron Technology, Inc., Boise, ID (US)

(72) Inventor: Lance W. Dover, Fair Oaks, CA (US)

(21) Appl. No.: 18/129,498

(22) Filed: Mar. 31, 2023

Related U.S. Application Data
(60) Provisional application No. 63/341,260, filed on May 12, 2022.

(51) Int. Cl. G06F 3/06

(52) U.S. Cl. CPC G06F 3/0622; G06F 3/0655; G06F 3/0679

(57) ABSTRACT

Methods, systems, and devices for performing cryptographic functions at a memory system are described to support integration of cryptographic primitives at a memory system to perform one or more cryptographic operations at the memory system. A host system may indicate, to a memory system, to perform one or more cryptographic operations, such as by sending a command to the memory system. In some cases, the indication may also include information associated with the cryptographic operation(s), an indication of an action to perform with a result of the cryptographic operation(s), or both. In response to the indication, the memory system may perform the indicated cryptographic operation(s) and may return, to the host system, an output associated with the cryptographic operation(s). The output may include a cryptographic value or data, an indication of a result of the cryptographic operation(s), an indication that the cryptographic operation(s) have been completed, or a combination thereof.

### CROSS REFERENCE

The present application for patent claims priority to U.S. patent application Ser. No. 63/341,260 by Dover et al., entitled “PERFORMING CRYPTOGRAPHIC FUNCTIONS AT A MEMORY SYSTEM” and filed May 12, 2022, which is assigned to the assignee hereof and is expressly incorporated by reference herein.

### FIELD OF TECHNOLOGY

The following relates to one or more systems for memory, including performing cryptographic functions at a memory system.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports performing cryptographic functions at a memory system in accordance with examples as disclosed herein.

FIG. 2 illustrates an example of a system that supports performing cryptographic functions at a memory system in accordance with examples as disclosed herein.

FIG. 3 illustrates an example of a system that supports performing cryptographic functions at a memory system in accordance with examples as disclosed herein.

FIG. 4 illustrates an example of a process flow that supports performing cryptographic functions at a memory system in accordance with examples as disclosed herein.

FIG. 5 shows a block diagram of a memory system that supports performing cryptographic functions at a memory system in accordance with examples as disclosed herein.

FIG. 6 shows a flowchart illustrating a method or methods that support performing cryptographic functions at a memory system in accordance with examples as disclosed herein.

### DETAILED DESCRIPTION

Integration of cryptographic operations into host or memory systems may increase security of such systems, performance capabilities of such systems, or both. As described herein, cryptographic operations may refer to one or more security techniques (e.g., to encrypt or decrypt data, to authenticate the source of data or other information). In some cases, hardware (e.g., relatively large or complex hardware) may be used to perform mathematical operations used in cryptographic operations. In some cases, this hardware (e.g., for cryptographic processes) may be integrated into digital logic devices (e.g., as dedicated hardware, or as a portion of dedicated hardware), such as an SoC, a processor, a microprocessor, or a dedicated cryptographic chip. However, dedicated cryptographic hardware may not be transferrable across devices (e.g., may be dedicated to one type of platform or device) which may increase cost. Additionally, including dedicated cryptographic hardware (e.g., a dedicated chip) within a system may increase a size of the system, a cost of the system, or both.

Techniques and methods described herein provide for the integration of cryptographic primitives at a memory system to perform one or more cryptographic operations at the memory system (e.g., for the memory system, for a host system). As described herein, cryptographic primitives may refer to one or more cryptographic techniques or algorithms (e.g., base techniques or algorithms) that may be used to perform cryptographic operations. Cryptographic primitives may be used as, or in, a general purpose cryptographic engine and may include one or more of a hashing engine, message authentication code (MAC) generation, MAC verification, key generation, signature generation, signature verification, encryption, and decryption, among other types of cryptographic operations. Integrating cryptographic primitives within a memory system may make inclusion of cryptographic hardware more versatile because memory systems may be uniform (or relatively uniform) across different systems and devices (e.g., for different logic devices, different platforms, different SoC devices).

A host system may indicate, to a memory system, to perform one or more cryptographic operations (e.g., using the cryptographic primitives at the memory system). For example, the host system may send a command to the memory system, indicating for the memory system to perform the cryptographic operation(s). In some cases, the indication to perform the one or more cryptographic operations may also include information associated with the cryptographic operation(s), an indication of an action to perform with a result of the cryptographic operation(s), or both. In response to the indication, the memory system may perform the indicated cryptographic operation(s) and may return, to the host system, an output associated with the cryptographic operation(s) (e.g., a cryptographic value or data, an indication of a result of the cryptographic operation(s), an indication that the cryptographic operation(s) have been completed).

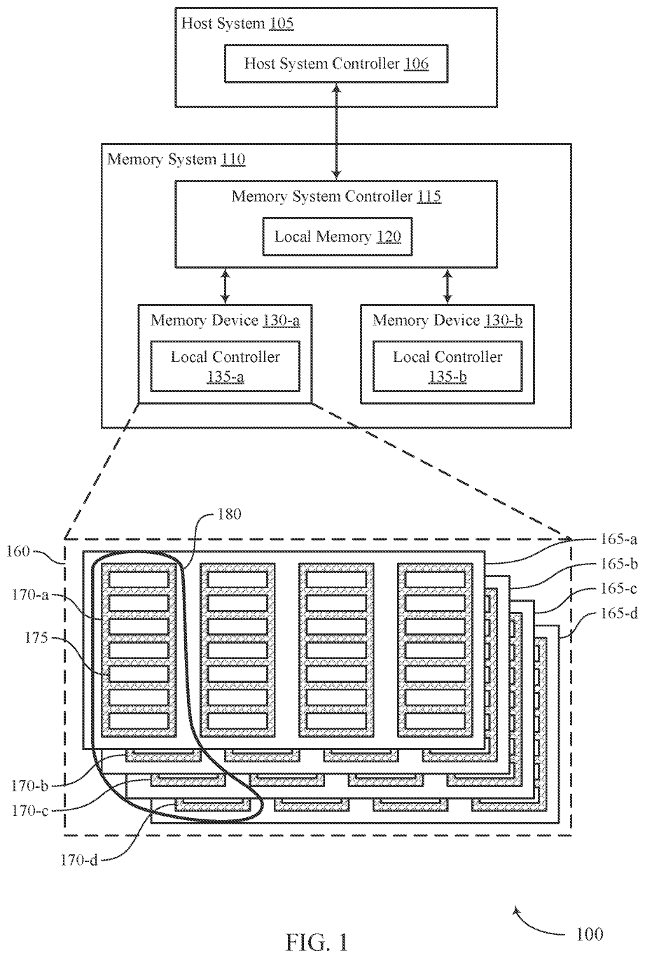

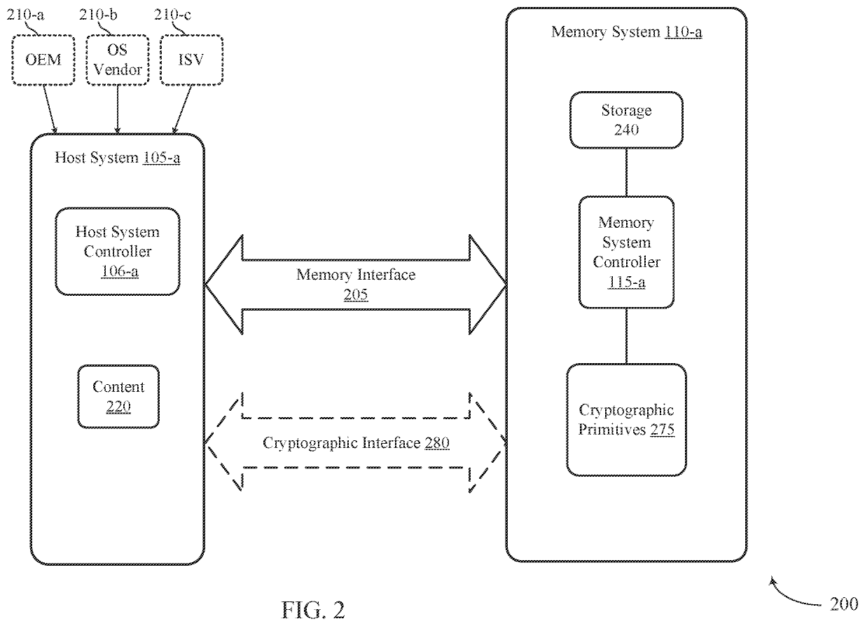

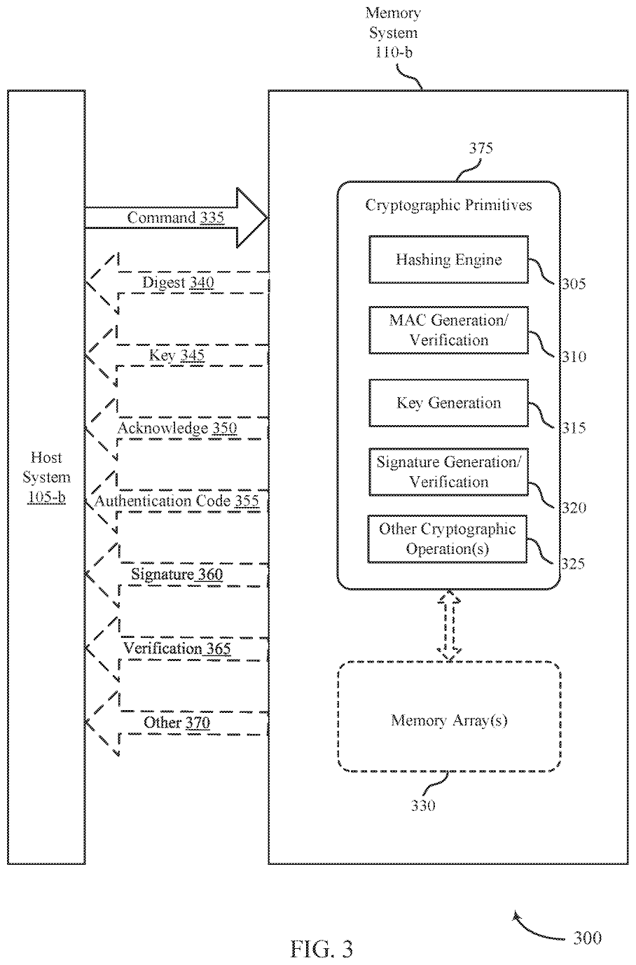

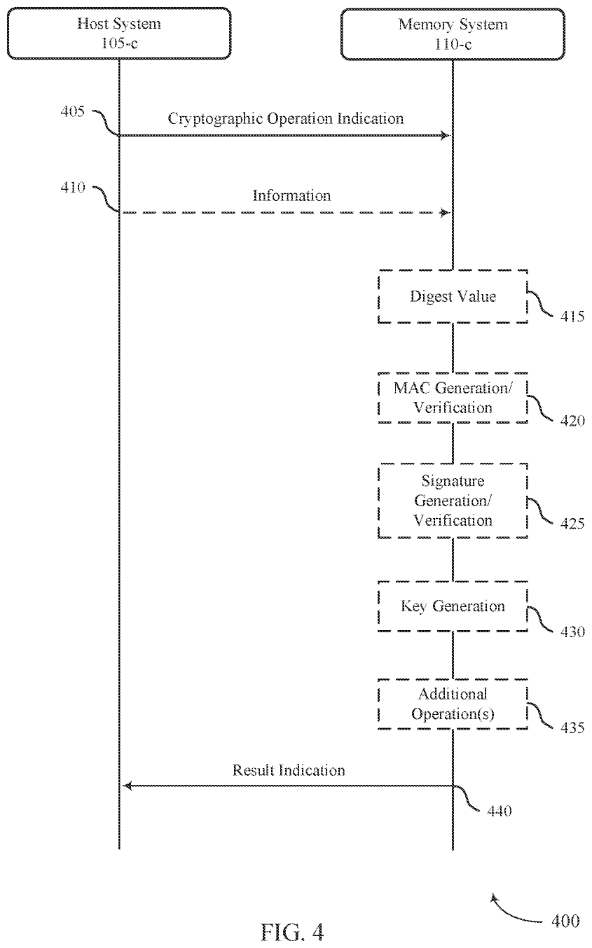

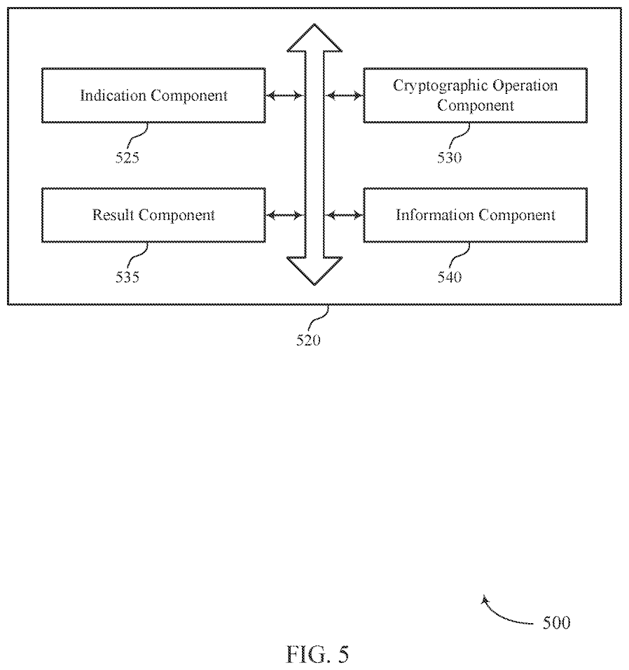

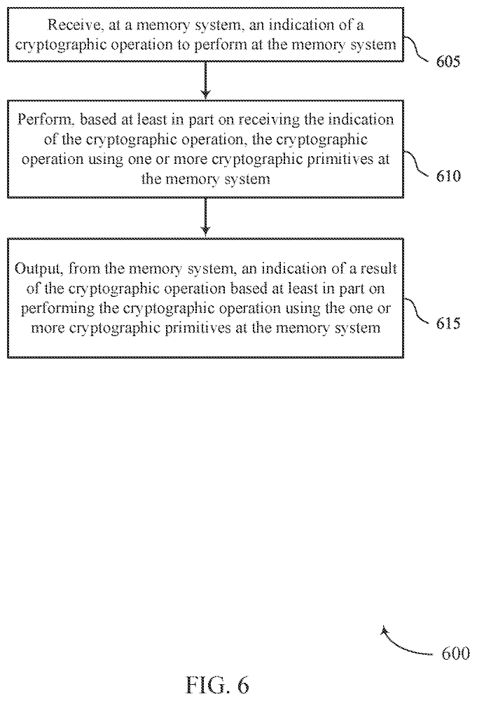

Features of the disclosure are initially described in the context of systems, devices, and circuits with reference to FIGS. 1 through 2. Features of the disclosure are described in the context of a system and a process flow with reference to FIGS. 3 and 4. These and other features of the disclosure are further illustrated by and described in the context of an apparatus diagram and flowchart that relate to performing cryptographic functions at a memory system with reference to FIGS. 5 and 6.

FIG. 1 illustrates an example of a system 100 that supports performing cryptographic functions at a memory system in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally or alternatively include static random access memory (SRAM) or other memory that may be used by the memory system controller 115 for internal storage or calculations, for example, related to the functions ascribed herein to the memory system controller 115. Additionally or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally or alternatively rely upon an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a memory die 160. For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may take place within different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The system 100 may include any quantity of non-transitory computer readable media that support performing cryptographic functions at a memory device. For example, the host system 105, the memory system controller 115, or a memory device 130 (e.g., a local controller 135) may include or otherwise may access one or more non-transitory computer readable media storing instructions (e.g., firmware) for performing the functions ascribed herein to the host system 105, memory system controller 115, or memory device 130. For example, such instructions, if executed by the host system 105 (e.g., by the host system controller 106), by the memory system controller 115, or by a memory device 130 (e.g., by a local controller 135), may cause the host system 105, memory system controller 115, or memory device 130 to perform one or more associated functions as described herein.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support performing cryptographic functions at a memory system. For example, the host system 105, the system controller 115, a memory device 130, or a memory device 130 may include or otherwise may access one or more non-transitory computer readable media storing instructions (e.g., firmware) for performing the functions ascribed herein to the host system 105, system controller 115, memory device 130, or memory device 130. For example, such instructions, if executed by the host system 105 (e.g., by the host system controller 106), by the system controller 115, by a memory device 130 (e.g., by a local controller 135), or by a memory device 130 (e.g., by a local controller 135), may cause the host system 105, system controller 115, memory device 130, or memory device 130 to perform associated functions as described herein.

In accordance with examples as disclosed herein, the host system 105 and the memory system 110 may be configured to implement various techniques for performing cryptographic operations using cryptographic primitives at the memory system 110 (e.g., to provide for more versatile and cost-effective cryptology). The host system 105 may transmit one or more commands, and associated information, indicating for the memory system 110 to perform one or more cryptographic operations (e.g., using the cryptographic primitives) and return a result of the cryptographic operation(s) to the host system 105. The cryptographic operations may include one or more of a hashing engine, MAC generation or verification, signature generation or verification, key generation, one or more other cryptographic operations, or any combination thereof.

FIG. 2 illustrates an example of a system 200 (e.g., a compute platform) that supports performing cryptographic operations at a memory system in accordance with examples as disclosed herein. The system 200 may include a host system 105-a and a memory system 110-a, which may be examples of the respective systems described with reference to FIG. 1. The host system 105-a and the memory system 110-a may implement various techniques for performing cryptographic operations (e.g., functions), which may include receiving a content and returning a digest, generating public or private key values, and generating or verifying signatures among other functions, among other examples. The host system 105-a may include a host system controller 106-a and the memory system 110-a may include a memory system controller 115-a, and, in some examples, the host system controller 106-a and the memory system controller 115-a may be configured to perform one or more of the described operations at the host system 105-a and the memory system 110-a, respectively.

Although techniques are described with reference to a single host system 105-a and a single memory system 110-a of the system 200, the described techniques may be extended to support implementations of a host system 105 that is coupled with any quantity of memory systems 110, or implementations of a memory system 110 that is coupled with any quantity of host systems 105, or implementations of a network of multiple host systems 105 coupled with multiple memory systems 110.

The host system 105-a may be an example of a system that uses at least a portion of the memory system 110-a (e.g., storage 240) for information storage, which may include various operations that support the host system 105-a writing information to the memory system 110-a, or the host system 105-a reading information from the memory system 110-a, or both. In some examples, the host system 105-a may be characterized as being “local,” which may refer to a relatively direct or proximal physical, electrical, or otherwise communicative coupling. In some other examples, the host system 105-a may be characterized as being “remote,” which may refer to a relatively distant (e.g., non-co-located) communicative coupling that may involve one or more wired, wireless, optical, or otherwise relatively distant communicative couplings, such as a cloud application or otherwise distributed compute system.

In some examples, the host system 105-a may include, may be coupled with, or may be otherwise associated with one or more host entities 210. Host entities 210 may be implemented as hardware entities, firmware entities, or software entities, and may include various serial, parallel, or hierarchical coupling or logical organization with or via the host system 105-a. In some examples, the host entities 210 may request or otherwise perform signaling with the memory system 110-a via a common controller or interface (e.g., via host system controller 106-a). In various examples, host entities 210 may be associated with different functions, different feature sets, different permissions, different storage attributes (e.g., data protection attributes), among other different characteristics.

The example of host system 105-a may be associated with an original equipment manufacturer (OEM) host entity 210-a, an operating system (OS) vendor host entity 210-b, and an independent software vendor (ISV) host entity 210-c. In some other examples, a host system 105 may include or be otherwise associated with any quantity of one or more host entities 210 including but not limited to one or more OEM host entities 210, OS vendor host entities 210, ISV host entities 210, or other types of host entities. In some examples, host entities 210 may be omitted or otherwise not separately considered.

In some examples, the host system 105-a may include content 220, which may refer to various types of information stored at the host system 105-a. In some examples, content 220 may be accessed or otherwise used to support cryptographic operations in accordance with examples as disclosed herein. In some examples, information associated with the content 220 may be transmitted to the memory system 110-a to support various authentication or encryption techniques (e.g., for the memory system 110-a to generate keys or certificates for operation with the memory system 110-a or to produce a hashing digest). For example, the content 220 may include metadata such as the address of the location in memory for measuring data. In other examples, the content 220 may include firmware of the host system 105-a, such as boot code (e.g., second-stage boot code, “L1” boot code), or a firmware security descriptor (FSD), which may be used to establish an operating or cryptographic state (e.g., a firmware state) of the host system 105-a. Additionally or alternatively, the content 220 may include a nonce or password. A nonce may refer to a random or pseudo random number that may include a timestamp appended to data during an authentication process to ensure that previous communications between devices are not being impersonated.

Additionally or alternatively, one or more components for storing the content 220 may be located outside the host system 105-a, but may be otherwise accessible by the host system 105-a (e.g., in a secure manner). In various examples, the content 220 may be stored using a non-volatile storage location (e.g., for information maintained for a relatively long time), or a volatile storage location (e.g., for information that is otherwise generated relatively frequently), or both. Although the content 220 is illustrated separately from the host system controller 106-a, in some examples, the content 220 may be part of or otherwise associated with the host system controller 106-a, such as a storage location that includes firmware for the host system 105-a or the host system controller 106-a.

The memory system 110-a may include storage 240, which may refer to a collective storage capacity of one or more instances of local memory 120, or of one or more memory devices 130, or various combinations thereof that are included in or are otherwise associated with the memory system 110-a. In some examples, the storage 240 may be divided or otherwise organized in partitions (e.g., memory ranges, address ranges), which may refer to various subsets or ranges of logical addresses or physical addresses of the associated local memory 120 or memory devices 130. In some examples, portions of the storage 240 may be assigned to or allocated to different functions or attributes, such as examples where one or more partitions of the storage 240 are associated with a respective one or more host entities 210.

For example, portions of storage 240 may be assigned with or updated with a protection attribute (e.g., enabling or disabling a write protection attribute, enabling or disabling a read protection attribute), which may be associated with various keys, authentications, or encryptions that are specific to a given host entity 210, or that are common to the host system 105-a in general, among other examples. In some examples, the partitions may be assigned with an initial range of addresses, and may be updated with an assignment to a different range of addresses, including an appending of additional new addresses, an assignment to a subset of the initial range of addresses (e.g., a trimming of ranges), or an assignment to an entirely new range of addresses.

In an example implementation, a first partition may be associated with the OEM host entity 210-c, a second partition may be associated with the OS vendor host entity 210-b, and a third partition may be associated with the ISV host entity 210-c. In some examples, a fourth partition may be unallocated (e.g., not dedicated to a certain purpose or entity, free space), or may be shared among multiple host entities 210, among other examples for allocating partitions. In some examples, partitions may be used to implement various cryptographic techniques. For example, each partition, or some portion of a partition, may be assigned with or updated with a protection attribute (e.g., enabling or disabling a write protection attribute, enabling or disabling a read protection attribute), which may be associated with various keys, authentications, or encryptions that are specific to a given host entity 210, or that are common to the host system 105-a in general, among other examples.

In some examples, the memory system 110-a may be associated with a location for storing authentication or encryption information (e.g., generated or received keys, certificates), such as storage 240. For example, the memory system 110-a may use the storage 240 to store one or more private keys associated with the memory system 10-a, or one or more public keys or certificates generated by the memory system 110-a, or one or more public keys or certificates received from the host system 105-a (or other host systems 105, not shown). In some examples, the storage 240 may include a secret (such as a private key) that is used for encryption or decryption of data and known to the memory system 110-a (e.g., only known to the memory system 110-a). Devices that share the same secret as host system 105-a may be able to generate the same key values and verify the same data. A private key stored in storage 240 may be used to generate a signature such that another device with a public key value may be able to verify the signature. Additionally or alternatively, the memory system 110-a may use a public key value in storage 240 to verify a received signature. Some keys stored in 240 may be examples of symmetric keys, such that a same key may be used in both encrypting and decrypting a set of data. Other keys may be examples of asymmetric keys, such that different key values may be used in encrypting and decrypting the data.

In various implementations, some signaling may be inaccessible from outside the memory system 110-a. Such inaccessibility may be supported by various implementations of including components involved in the described cryptographic techniques in a portion of the memory system 110-a where attempts to access such components would be destructive to the components, or where such components or associated signaling may otherwise be shielded from destructive or non-destructive probing or snooping techniques. For example, components involved in the described cryptographic techniques (e.g., one or more components included in the cryptographic primitives 275, which may include at least a portion of the memory system controller 115-a or at least some portion thereof), if not all the components of the memory system 110-a, may be implemented in a contiguous semiconductor chip such as an SoC implementation.

In some examples, the memory system 110-a may include a public key table (e.g., an elliptical curve cryptography public key table), which may be configured to store, organize, or allocate public keys such as those received from the host system 105-a, or those generated in the cryptographic primitives 275 (e.g., at the memory system 110-a), or both. In some examples (e.g., in implementations where host entities 210 are associated with respective public keys that are transmitted by the host system 105-a), the public key table may hold a respective public key, or mapping thereof, for each of the OEM host entity 210-a, the OS vendor host entity 210-b, and the ISV host entity 210-c.

In some examples, the system 200 may be configured to support a signing and verifying (e.g., authentication) of signaling between the host system 105-a and the memory system 110-a (e.g., in accordance with signed command signaling, signed request signaling, signed data signaling, or signed response signaling), which may be implemented to authenticate the transmitting system of such signaling, or to ensure that the signaling has not been altered before being received by a receiving system, or both. In accordance with such techniques, a receiving system may be able to evaluate received signaling to determine whether transmitted signaling was transmitted by an unverified or unauthorized transmitting system, or whether the transmitted signaling was altered or otherwise compromised. In some examples, such techniques may support a one-to-many security arrangement, since multiple receiving systems may be able to implement a same public key (e.g., of an asymmetric key pair) of the transmitting system that is associated with a single private key (e.g., of the asymmetric key pair) of the transmitting system.

In some examples for signing and verifying signaling between the host system 105-a and the memory system 110-a, a signature for a given instance of signaling (e.g., a message, a command, a request, a data packet, a response) may be derived by hashing or otherwise processing the instance of signaling with a function (e.g., a hash function, a cryptographic hash algorithm) that receives, as an input, the instance of signaling and a private key associated with the transmitting system. The output of such a function (e.g., a signature, a hash digest) may be recreated using the same function with the same instance of signaling and either the same private key associated with the transmitting system or an associated public key (e.g., of an asymmetric key pair) associated with the transmitting system.

To support verifying the authenticity of the transmitting system, the transmitting system may transmit the instance of signaling along with the corresponding signature, which may be received by a receiving system. The receiving system may have received or otherwise generated the associated public key of the transmitting system and, accordingly, may generate a trial signature based on the received instance of signaling and the associated public key of the transmitting system. If the trial signature matches the received signature, the receiving system may determine that the transmitting system was authentic (e.g., that the instance of signaling is a transmission from a trusted system) and may continue with processing or otherwise performing a responsive action to the received instance of signaling. In some implementations, signature generation may be configured such that, even if an instance of signaling is the same, a generated signature will be different. In such implementations, signature generation and verification operations may be further based on a random number, a nonce, or a monotonic counter that is understood to both the transmitting system and the receiving system.

In some examples, the system 200 may be configured to support an encryption and decryption of signaling between the host system 105-a and the memory system 110-a (e.g., in accordance with encrypted signatures, encrypted command signaling, encrypted request signaling, encrypted data signaling, or encrypted response), which may be implemented to secure the contents of such signaling from being intercepted and interpreted or otherwise processed (e.g., to maintain integrity of the signaling itself). In accordance with such techniques, a transmitting system may encrypt instances of signaling for transmission using a key (e.g., of a symmetric key pair) known to the transmitting system, and a receiving system may decrypt received instances of such signaling using a key known to the receiving system (e.g., of the same symmetric key pair), which may be the same as the symmetric key known to the transmitting system, or may be otherwise equivalent or operable for such decryption. In some examples, such techniques may support a one-to-one security arrangement, since a symmetric key pair may be understood to a single transmitting system and a single receiving system (e.g., if a symmetric key pair is based on unique identifiers of each of the transmitting system and the receiving system). However, some cryptographic techniques may support arrangements other than a one-to-one security arrangement, such as if symmetric keys are based on unique identifiers of more than two systems.

Some implementations of the described techniques may utilize asymmetric cryptography where a public key associated with the host system 105-a may be uploaded to one or more memory systems 110 (e.g., the memory system 110-a) without exposing a private key of the host system 105-a, which may prevent an adverse actor from stealing the key and impersonating the real key holder (e.g., impersonating the host system 105-a). Such techniques may also allow a public key to be replaced, which may be different than other techniques such as those related to a relay-protected memory block (RPMB) or a replay-protection monotonic counter (RPMC). In some examples, such asymmetric cryptography techniques may facilitate the use of public key infrastructure (PKI) techniques, where keys may be verified through a standardized digital certificate chain.

In some implementations, the exchange of public keys may support the generation of symmetric keys at each of the host system 105-a and the memory system 110-a using such techniques as a Diffie-Hellman key exchange or elliptic-curve techniques, so that a symmetric secret can be shared between device and host without exposing the private keys of the respective systems. In some implementations, an asymmetric Diffie-Hellman key exchange can be performed between the host system 105-a and the memory system 110-a to generate symmetric keys that are then used to enable better performance at the host system 105-a or the memory system 110-a for authentication, encryption, or both. Further, ephemeral symmetric keys can be derived using a same algorithm shared by the host system 105-a and the memory system 110-a to make it more difficult for an adverse actor to extract or replicate such keys, based on various techniques for duration-initiated or event-initiated generation of ephemeral keys.

In some examples, the exchange of public keys may be associated with the creation of digital certificates, which may include various signaling with or other interaction with one or more certificate authorities or registration authorities, or may involve self-signed certificates, or various combinations thereof. For example, the host system 105-a, or a cloud authority or other centralized certification authority in communication with the host system 105-a, may create a certificate signing request (CSR), which may be an example of a self-signed certificate that proves that memory system 110-a has the private key associated with the public key in the CSR. In some examples, such a CSR may be transferred from the memory system 110-a to a centralized certification authority as part of a manufacturing operation (e.g., for manufacturing the memory system 110-a). In some implementations, in response to an identity of the memory system 110-a being confirmed (e.g., by a cloud authority, by a vendor certification), a manufacturer-endorsed certificate may be provided to the host system 105-a, to the memory system 110-a, or to both. In some examples, such techniques may support a requesting system downloading a manufacturer-endorsed certificate (e.g., a certificate endorsed by a certificate authority) or downloading the CSR.

The integration of cryptographic functionality into host or memory systems (e.g., computer systems) may increase security and performance. In some cases, hardware (e.g., relatively complex hardware) may be used to perform mathematical operations (e.g., relatively complex mathematical operations) used in cryptographic processes. In some cases, this hardware (e.g., for cryptographic processes) may be integrated into digital logic devices (e.g., as dedicated hardware, or as a portion of dedicated hardware), such as an SoC, a processor, a microprocessor, or a dedicated cryptographic chip. However, dedicated cryptographic hardware may not be transferrable across devices (e.g., may be dedicated to one type of platform or device) which may increase cost. Additionally, including dedicated cryptographic hardware (e.g., a dedicated chip) within a system may increase a size of the system, a cost of the system, or both.

Techniques and methods described herein provide for the integration of cryptographic primitives at a memory system 110 (e.g., at memory system 110-a) to perform one or more cryptographic operations at the memory system 110 (e.g., for the memory system 110, for a host system 105). Cryptographic primitives, such as cryptographic primitives 275, may be used as a general purpose cryptographic engine and may include one or more of a hashing functionality, MAC generation, MAC verification, key generation, signature generation, and signature verification, among other types of cryptographic operations. Integrating cryptographic primitives within a memory system may make inclusion of cryptographic hardware more versatile since memory systems may be uniform across different systems (e.g., for different logic devices, different platforms, different SoC devices).

In some cases, cryptographic primitives 275 integrated within a memory system 110-a may be accessed using a memory interface 205 (e.g., an existing memory interface 205). In such cases, the host system 105-a may differentiate commands for the cryptographic primitives 275 from memory access commands by using a modified version of the memory access commands (e.g., indicating that the command is a cryptographic command). In other cases, the host system 105-a may use a dedicated cryptographic interface 280 (e.g., a dedicated physical and logical interface), which may be used to communicate dedicated cryptographic commands and information. In such cases, the memory system 110 may include one or more connections to facilitate interaction between the cryptographic primitives 275 and the memory (e.g., the storage 240, one or more memory arrays, one or more memory devices).

FIG. 3 illustrates an example of a system 300 that supports performing cryptographic functions at a memory system in accordance with examples as disclosed herein. The system 300 may include a host system 105-b and a memory system 110-b, which may be examples of a host system 105 and a memory system 110 described with reference to FIGS. 1 and 2. For example, the host system 105-b and the memory system 110-b may be coupled with, or otherwise interface with, each other. The memory system 110-b may include one or more components, features, or means, related to cryptographic primitives 375, which may be operable to perform one or more cryptographic functions.

The cryptographic primitives 375 may be implemented in a memory die or chip or spread across multiple memory dies or chips within the memory system 110-b. In some cases, the cryptographic primitives 375 may be implemented at a controller or controller chip of the memory system 110-b. As described with reference to FIG. 2, the host system 105-b may interface with the cryptographic primitives 375 over a memory access interface or a dedicated cryptographic interface. For example, the host system 105-b may request cryptographic primitives 375 to perform one or more cryptographic operations by sending a command 335 (e.g., in conjunction with a read or write command) to memory system 110-b. In some cases, the host system 105-b may issue a command 335 that may be an example of a dedicated cryptographic command (e.g., via a dedicated interface). In some cases, the host system 105-b may issue a command 335 that may be an example of a modified memory access command, and the memory system 110-b may interpret the command 335 as a request for performing cryptographic operations. For example, command 335 may include a sequence of operations indicating to interpret the command 335 as being associated with cryptographic operations. Additionally or alternatively, data included in the command 335 (e.g., independently or coupled with the sequence of operations) may indicate to the memory system 110-b that the command 335 is to be interpreted as a command for the cryptographic primitives 375 (e.g., a measurement command).

The cryptographic primitives 375 may include components, features, or means to perform one or more cryptographic operations. For example, the cryptographic primitives may include components, features, algorithms, or other means associated with a hashing engine 305, MAC generation or verification (generation/verification) 310, key generation 315, signature generation or verification (generation/verification) 320, or one or more other cryptographic operations 325. Further, as used herein, a cryptographic primitive may refer to a component (e.g., a hardware component, a software or firmware component, or any combination thereof) for implementing an associated operation or to the operation itself. In some cases, the components, features, or means to perform respective operations of the cryptographic primitives 375 may be connected or coupled with each other. For example, MAC generation/verification 310 and a key generation 315 (e.g., among other cryptographic primitives described herein) may be implemented independently within the memory system 110-b and the associated components or portions of the cryptographic primitives 375 may interface or otherwise be coupled with each other. In one example, the MAC generation/verification 310 may use a secret (e.g., private key) to generate a digest. In some cases, if the secret is not already stored in memory array 330 or received by the memory system 110-b, the secret may be generated by a key generation 315. In this case, the key generation 315 may be associated with the MAC generation/verification 310 such that the MAC generation/verification 310 may access or receive the secret.

In some cases, the cryptographic primitives 375 may be implemented by a same component, or a portion of a component, of the memory system 110-b. For example, a hashing engine 305 may be implemented as a component within memory system 110-b and may be accessed (e.g., by the host system 105-b) to produce a digest 340. In some cases, a MAC generation/verification 310 may be implemented as an algorithm that uses the hashing engine 305 to produce a MAC. The MAC output from the MAC generation/verification 310 may vary from the output of the hashing engine operation in that the MAC is based on (e.g., generated using) a secret known to the memory system 110-b. However, the MAC generation/verification 310 may be implemented as an operation by the hashing engine 305 that takes an additional input (e.g., a secret), and may be associated with a same component of the memory system 110-b (e.g., a same component or portion of the cryptographic primitives).

In some cases, the cryptographic primitives 375 may be implemented separately from one or more memory arrays 330 of the memory system 110-b, but may be operable to interface, or communicate with, the memory array(s) 330. In some cases, the cryptographic primitives 375 may be implemented (e.g., at least partially implemented) using the memory array(s) 330 (e.g., within, or as part of, the memory array(s) 330). In such cases, the cryptographic primitives 375 may be operable to interface, or communicate with, one or more other portions of the memory array(s) 330 in which the cryptographic primitives 375 are implemented, one or more other memory arrays 330 of the memory system 110-b, or both. For example, whether the cryptographic primitives 375 are implemented in the memory array(s) 330, independent of the memory array(s), or both, the cryptographic primitives 375 may access data (e.g., information, such as for a cryptographic operation) stored at the memory array(s) 330, send data to be stored at the memory array(s) 330 (e.g., store a result or output of a cryptographic operation), use a portion of the memory array(s) 330 to perform one or more cryptographic operations, or any combination thereof.

The cryptographic primitives 375 may be available for use by the host system 105-b, by the memory system 110-b, or both. For example, the host system 105-b may indicate for the memory system 110-b to perform one or more of the cryptographic operations (e.g., as part of host system processes or management) and may also indicate an action for the memory system 110-b to perform with a result of the cryptographic operation(s). In some cases, the host system 105-b may indicate for the memory system 110-b to perform the cryptographic operation(s) in connection with reading data, writing data, or independently of such operations. Additionally or alternatively, the memory system 110-b may perform one or more of the cryptographic operations (e.g., as part of memory system processes or management, in response to a command) and may use or otherwise output a result of the cryptographic operation(s).

The cryptographic primitives 375 may include a hashing engine 305 for creating (e.g., outputting) a digest 340 (e.g., a hash, a hash value, a fingerprint, a consolidation of what is measured by the hashing engine 305). In some cases, the host system 105-b may initiate a hashing operation by sending a command 335 that may be an example of a measurement request. In some cases, the command 335 may also include metadata such as a memory address, nonce, constant values, or other relevant information to be used by the hashing function. In a first example, the requested measurement may be performed by the cryptographic primitives 375 by retrieving data from memory array(s) 330 and applying a mathematical hashing function to the data (e.g., content) to produce a hashed value (e.g., digest 340). For example, the command 335 may include a request to measure content stored in memory, and the hashing engine 305 may retrieve the data stored in memory array(s) 330 and input the data into a hashing function (e.g., hashing operation). The resulting digest 340 may verify (e.g., to the host system 105-b) if the content stored in the memory array(s) 330 is expected content (e.g., correct or accurate content).

In a second example, the requested measurement may be performed on information or data (e.g., content) included in the command 335 and indicated by the host system 105-b as being the information for the measurement. In such cases, the cryptographic primitives 375 may apply a mathematical hashing function to the information to produce a hashed value (e.g., digest 340). For example, the hashing engine 305 may input the information into a hashing function (e.g., hashing operation), where the resulting digest 340 may verify if the content stored received from the host system 105-b is expected content.

In a third example, the requested measurement may be performed using information or data (e.g., content) included in the command 335 and data store at the memory array(s) 330. For example, the command 335 may include a request to measure content stored in the memory array(s) 330, and an address of the location in the memory array(s) 330 where the content is stored (e.g., along with other possible metadata associated with the content). The hashing engine 305 may retrieve the data stored in the memory array(s) 330 at the specified memory location and input the data into the hashing function. The resulting digest 340 may verify both that the content of the data is expected and the location of the content of the data is expected.

The cryptographic primitives 375 may also include a MAC generation/verification 310 (e.g., hashing-based message authentication code (HMAC) generation or verification, cipher-based message authentication code (CMAC)). A command 335 that requests MAC generation may include an indication of a content to measure and an associated symmetric secret (e.g., a symmetric key). As described with respect to the hashing engine 305, the content may be retrieved from the memory array(s) 330, the content may be included in the command 335, or some combination thereof. The content may be received, retrieved, or both, and combined with a secret (e.g., a symmetric key) to produce a hashed code (e.g., an authentication code 355). The secret may be known to the memory system 110-b (e.g., known only to the memory system 110-b), may be included in the command 335, or some combination thereof. In some cases, the secret may be stored at the memory system 110-b (e.g., at the memory array(s) 330). In other cases, the secret may be generated by another cryptographic primitive 375 (e.g., the key generation 315). The content and the secret may be input to a MAC algorithm (e.g., HMAC algorithm, CMAC algorithm). In some cases, a hashing engine may be an example of a MAC algorithm. MAC generation/verification 310 may return an authentication code 355 (e.g., to the host system 105-b) that verifies that the content and secret are correct (e.g., are expected or accurate).

In some cases, the host system 105-b may request MAC verification (e.g., HMAC verification, CMAC verification). In this case, the command 335 may include a MAC, or an indication of a MAC (e.g., stored at the memory system 110-b), to be verified. The command may also include an indication of the content that produced the MAC (e.g., content stored at the memory system 110-b, included in the command 335, or a combination thereof) and an associated key (e.g., included in the command 335, stored at the memory system 110-b, generated by the memory system 110-b). The MAC generation/verification 310 may generate a MAC based on (e.g., using) the indicated content and the associated secret, and may compare the result to the received (e.g., indicated) MAC. If the two MAC values are the same, a verification 365 may be sent to the host system 105-b. In some cases, the verification 365 may be considered an authentication for the content, the secret, or both, and may be used to authenticate the host system 105-b or one or more commands associated with the host system 105-b. If the MAC values are not the same, a negative verification 365 may be sent to the host system 105-b, where differences in MAC values may be due to differences in the content, the secret, or both (e.g., indicating an inaccuracy, an unexpected result, an insecure result).

The cryptographic primitives 375 may also include a key generation 315 (e.g., symmetric or asymmetric key generation). The key generation 315 may be operable to generate a symmetric key (e.g., associated with MAC techniques), an asymmetric key (e.g., associated with signature techniques), or both. A command 335 that requests key generation may include information such as a nonce or password to be used in generating the key. In some cases, a random or pseudo-random number generator may be an example of the key generation 315. Additionally or alternatively, a hashing engine may be an example of the key generation 315. Information included in the command 335 may be input to the key generating algorithm (e.g., random number generator, hashing engine) to produce a key value. Elliptic curve cryptology and Rivest-Shamir-Adleman may be examples of cryptographic algorithms used in the key generation 315 (e.g., among other examples). In some cases, the key generation 315 may utilize additional information known to the memory system 110-b (e.g., information, data stored at the memory system 110-b). The key 345 may be an example of a public key, a private key, a symmetric key, or an asymmetric key.

The key 345 may be returned to the host system 105-b, or may be stored at the memory system 110-b (e.g., at the memory array(s) 330). For example, the command 335 may indicate to return the key 345 to the host system 105-b or store the key at the memory system 110-b. In some cases (e.g., in response to storing the key 345 at the memory system 110-b), a location of the generated key 345 may be returned instead of the key value, which may prevent the key value from being exposed. For example, the memory system 110-b may provide an acknowledge 350 that the key 345 has been generated, where the acknowledge 350 may include an indication of a location of the key 345. In some cases, the memory system 110-b may return a generated public key 345 to the host system 105-b and may retain an associated, generated private key 345 at the memory system 110-b. A generated key value may be used outside of the memory system 110-b (e.g., by the host system 105-b), or may be used by the memory system 110-b, in generation or verification processes (e.g., as a secret for MAC generation). In some cases, the generated key may be a symmetric key, such that another device with the same information may generate the same key value.

The cryptographic primitives 375 may also include signature generation/verification 320, where a signature 360 may refer to a value that may be generated based on (e.g., using) data (e.g., information) and a secret that may be known to the memory system 110-b (e.g., a private key, known only to the memory system 110-b). Other devices or components may verify a signature 360 using a public key. The signature generation/verification 320 may be similar to the MAC generation/verification 310, but may use an asymmetric algorithm (e.g., an asymmetric key). A command 335 that requests signature generation may include an indication of a content to measure and an associated symmetric secret (e.g., a symmetric key). As described with respect to the hashing engine 305 and the MAC generation/verification 310, the content may be retrieved from the memory array(s) 330, the content may be included in the command 335, or some combination thereof. The content may be received, retrieved, or both, and combined with a secret (e.g., an asymmetric key, a private key of the asymmetric key) to produce a signature 360. The secret may be known to the memory system 110-b (e.g., known only to the memory system 110-b), may be included in the command 335, or some combination thereof. In some cases, the secret may be stored at the memory system 110-b (e.g., at the memory array(s) 330). In other cases, the secret may be generated by another cryptographic primitive 375 (e.g., the key generation 315). The content and the secret may be input to a signature generation algorithm. In some cases, a hashing engine may be an example of a signature generation algorithm. Signature generation/verification 320 may return a signature 360 (e.g., to the host system 105-b) that verifies that the content and secret are correct (e.g., are expected or accurate).

In some cases, the host system 105-b may request signature verification. In this case, the command 335 may include a signature, or an indication of a signature (e.g., stored at the memory system 110-b), to be verified. The command may also include an indication of the content that produced the signature (e.g., content stored at the memory system 110-b, included in the command 335, or a combination thereof) and an associated public key (e.g., included in the command 335, stored at the memory system 110-b, generated by the memory system 110-b). The signature generation/verification 320 may generate a signature based on (e.g., using) the indicated content and the associated secret, and may compare the result to the received (e.g., indicated) signature. If the two signature values are the same, a verification 365 may be sent to the host system 105-b. In some cases, the verification 365 may be considered an authentication for the content, the secret, or both, and may be used to authenticate the host system 105-b or one or more commands associated with the host system 105-b. If the signature values are not the same, a negative verification 365 may be sent to the host system 105-b, where differences in signature values may be due to differences in the content, the secret, or both (e.g., indicating an inaccuracy, an unexpected result, an insecure result).

The cryptographic operations that may be implemented within the memory system 110-b are not limited to the examples described herein. One or more other cryptographic operations 325 may additionally or alternatively be implemented, as may be appreciated by one of skill in the art. The other cryptographic operation(s) 325 may be similarly requested through a command 335 that may include an indication of the cryptographic operation(s), additional information associated with the cryptographic operation(s), an indication of an action to take with a result of the cryptographic operation(s), or a combination thereof. In some cases, the other cryptographic operation(s) 325 may output values similar to those previously discussed. In some cases, the other cryptographic operation(s) 325 may output one or more other values 370 which may be stored at the memory system 110-b or sent to the host system 105-b.

In one example, another cryptographic operation 325 may include encryption of data by the cryptographic primitives 375 at the memory system 110-b. For example, the command 335 may include data to be encrypted and an indication to encrypt the data (e.g., using a key indicated in the command 335 or stored at the memory system 110-b) and send the encrypted data to the host system 105-b, or an indication to encrypt data stored at the memory array(s) 330 and send the encrypted data to the host system 105-b. In some other cases, the command 335 may include data to be encrypted (e.g., with a key indicated in the command 335 or stored at the memory system 110-b) and an indication to store the encrypted data at the memory system 110-b (e.g., at the memory array(s) 330). The key used to encrypt the data may be generated by the memory system 110-b or received from the host system 105-b, and may be an example of a symmetric key or an asymmetric key (e.g., in which the memory system 110-b may use a public key to encrypt).

FIG. 4 illustrates an example of a process flow 400 that supports performing cryptographic functions at a memory system in accordance with examples as disclosed herein. Operations of the process flow 400 may be performed by a host system 105-c and a memory system 110-c, which may be examples of the respective systems described with reference to FIGS. 1-3. Aspects of the process flow 400 may be implemented by one or more controllers (e.g., one or more respective controllers at each of the host system 105-c and the memory system 110-c), among other components. Additionally or alternatively, aspects of the process flow 400 may be implemented as instructions stored in memory (e.g., respective firmware stored in a memory of or coupled with the host system 105-c and the memory system 110-c). For example, the instructions, if executed by a controller, may cause a controller to perform one or more operations of the process flow 400.

At 405, an indication of a cryptographic operation to perform may be received (e.g., by the memory system 110-c from the host system 105-c). For example, the command 335 described with reference to FIG. 3 may be an example of the indication received at 405. In some cases, the indication may be received over a memory interface 205 (e.g., a bus operable for receiving access commands, data, or both, for memory cells of the memory system 110-c), or a cryptographic interface 280 (e.g., a bus not operable for receiving access commands or data), as described with reference to FIG. 2. In some cases, the indication may not be associated with any access command for the memory cells of the memory system 110-c (e.g., the indication may not indicate for the memory system 110-c to access memory cells).

The indication to perform the cryptographic operation may include an indication of the cryptographic operation to perform, and as described at 410, in some cases may include additional information associated with the cryptographic operation. The indication to perform the cryptographic operation may also include an indication of an action to perform with a result of the cryptographic operation (e.g., store the result, output the result to the host system 105-c).

At 410, in some cases, additional information associated with the cryptographic operation may be received (e.g., by the memory system 110-c from the host system 105-c). For example, as described with reference to FIG. 3, the cryptographic operation may be associated with additional information provided by the host system 105-c to the memory system 110-c (e.g., provided with the indication to perform the cryptographic operation). The information received at 410 may include metadata associated with data stored in memory, input data (e.g., information, content) for the cryptographic operation, a nonce, a password, other data, or any combination thereof.

The memory system 110-c may perform the cryptographic operation using the cryptographic primitives 375 described with reference to FIG. 3. For example, at 415, in some cases (e.g., if the indication of the cryptographic operation indicates to generate a digest value), a digest value may be generated using a set of information (e.g., stored at the memory system 110-c, received from the host system 105-c, or a combination thereof). The digest value may be generated using the cryptographic primitives at the memory system 110-c, for example, as described with reference to FIG. 3.

At 420, in some cases (e.g., if the indication of the cryptographic operation indicates to generate an authentication code), an authentication code (e.g., a MAC) may be generated using a cryptographic key (e.g., stored at the memory system 110-c or received from the host system 105-c) and a set of information (e.g., stored at the memory system 110-c, received from the host system 105-c, or a combination thereof). The authentication code may be generated using the cryptographic primitives at the memory system 110-c, for example, as described with reference to FIG. 3. In some cases, the cryptographic key may be generated using a key generation operation (e.g., at 425). In some examples, the cryptographic key may be a symmetric key generated using a random number.

In some cases, the authentication code may be verified by the memory system 110-c after generating the authentication code. For example, the information received at 410 may include an indication of an authentication code to verify, and the memory system 110-c may compare the generated authentication code with the received authentication code (e.g., to determine whether the codes are the same).

At 425, in some cases (e.g., if the indication of the cryptographic operation indicates to generate a signature), an authentication code (e.g., a signature) may be generated using a cryptographic key (e.g., stored at the memory system 110-c or received from the host system 105-c) and a set of information (e.g., stored at the memory system 110-c, received from the host system 105-c, or a combination thereof). The authentication code (e.g., signature) may be generated using the cryptographic primitives at the memory system 110-c, for example, as described with reference to FIG. 3. In some cases, the cryptographic key may be generated using a key generation operation (e.g., at 425). In some examples, the cryptographic key may be an asymmetric key generated using a nonce.

In some cases, the signature may be verified by the memory system 110-c after generating the signature. For example, the information received at 410 may include an indication of a signature to verify, and the memory system 110-c may compare the generated signature with the received signature (e.g., to determine whether the signatures are the same).

At 430, in some cases (e.g., if the indication of the cryptographic operation indicates to generate a cryptographic key, if a cryptographic key is to be used in another operation), a cryptographic key may be generated. The cryptographic key may be generated using the cryptographic primitives at the memory system 110-c, for example, as described with reference to FIG. 3. In some cases, the key may be generated using a password, a nonce, a random number, metadata, or other data, as described herein. In some cases, the memory system 110-c may store the key or may output the key to the host system 105-c.

The memory system 110-c may be capable of implementing one or more additional cryptographic operations that may not be described herein, but which may be appreciable to one of skill in the art. For example, at 435, the one or more additional cryptographic operations may be performed (e.g., using the cryptographic primitives at the memory system 110-c). Such cryptographic operations may be examples of cryptographic operation(s) 325 and may, in some cases, be associated with additional information.

One example of the performing the additional cryptographic operation(s) may include encrypting data using the cryptographic primitives. For example, the memory system 110-c may perform encryption or decryption of data as described with reference to FIG. 3 (e.g., in association with a key generated the key generation 425). In some cases, the encrypted data may be stored at the memory system 110-c.

At 440, an indication of a result of the cryptographic operation may be output based on (e.g., in response to) performing the cryptographic operation. For example, the memory system 110-c may output a result indication of the cryptographic operation based on (e.g., in response to) performing the cryptographic operation using the cryptographic primitives. A digest may be an example of a result indication output by the memory system 110-c (e.g., to the host system 105-c), for example, in the case of generating a digest value at 415.

In some cases, the result indication output at 440 may include an authentication code (e.g., a MAC, a signature), for example, in the case of generating the authentication code (e.g., MAC, signature) at 420 or 425. Additionally or alternatively, the result indication output at 440 may include an indication of whether the authentication code (e.g., MAC, signature) was verified, for example, in the case of performing verification on the authentication code at 420 or 425. In some cases, the result indication may include a key generated at 425. In some cases, the result indication may include an indication that data has been encrypted (e.g., and stored at the memory system 110-c). In some other cases, the result indication may include encrypted data.

FIG. 5 shows a block diagram 500 of a memory system 520 that supports performing cryptographic functions at a memory system in accordance with examples as disclosed herein. The memory system 520 may be an example of aspects of a memory system as described with reference to FIGS. 1 through 4. The memory system 520, or various components thereof, may be an example of means for performing various aspects of performing cryptographic functions at a memory system as described herein. For example, the memory system 520 may include an indication component 525, a cryptographic operation component 530, a result component 535, an information component 540, or any combination thereof. Each of these components may communicate, directly or indirectly, with one another (e.g., via one or more buses).

The indication component 525 may be configured as or otherwise support a means for receiving, at a memory system, an indication of a cryptographic operation to perform at the memory system. The cryptographic operation component 530 may be configured as or otherwise support a means for performing, based on receiving the indication of the cryptographic operation, the cryptographic operation using one or more cryptographic primitives at the memory system. The result component 535 may be configured as or otherwise support a means for outputting, from the memory system, an indication of a result of the cryptographic operation based on performing the cryptographic operation using the one or more cryptographic primitives at the memory system.

In some examples, to support performing the cryptographic operation, the cryptographic operation component 530 may be configured as or otherwise support a means for generating, using the one or more cryptographic primitives at the memory system, a digest value using a set of information, where the indication of the result of the cryptographic operation includes an indication of the digest value.

In some examples, the information component 540 may be configured as or otherwise support a means for receiving, in association with the indication of the cryptographic operation, a first subset of the set of information used to generate the digest value. In some examples, a second subset of the set of information includes data stored at the memory system prior to the indication of the cryptographic operation being received. In some examples, the first subset of the set of information includes metadata associated with the second subset of the set of information. In some examples, the first subset of the set of information includes input data for the one or more cryptographic primitives. In some examples, the set of information includes data stored at the memory system prior to the indication of the cryptographic operation being received.

In some examples, to support performing the cryptographic operation, the cryptographic operation component 530 may be configured as or otherwise support a means for generating, using the one or more cryptographic primitives at the memory system, an authentication code using a set of information and a cryptographic key.

In some examples, the information component 540 may be configured as or otherwise support a means for receiving, in association with the indication of the cryptographic operation, a first subset of the set of information used to generate the authentication code. In some examples, a second subset of the set of information includes data stored at the memory system prior to the indication of the cryptographic operation being received. In some examples, the first subset of the set of information includes metadata associated with the second subset of the set of information. In some examples, the first subset of the set of information includes input data for the one or more cryptographic primitives. In some examples, the set of information includes data stored at the memory system prior to the indication of the cryptographic operation being received.

In some examples, the information component 540 may be configured as or otherwise support a means for receiving, at the memory system, an indication of the cryptographic key, where generating the authentication code is based at least in part receiving the indication of the cryptographic key. In some examples, the cryptographic operation component 530 may be configured as or otherwise support a means for identifying, at the memory system, the cryptographic key based on information stored at the memory system, information received by the memory system, or both. In some examples, the cryptographic key is a symmetric key or an asymmetric key.

In some examples, to support outputting the indication of the result of the cryptographic operation, the result component 535 may be configured as or otherwise support a means for outputting the authentication code from the memory system. In some examples, to support outputting the indication of the result of the cryptographic operation, the result component 535 may be configured as or otherwise support a means for outputting an indication of whether the authentication code is verified.

In some examples, to support performing the cryptographic operation, the cryptographic operation component 530 may be configured as or otherwise support a means for generating a cryptographic key using the one or more cryptographic primitives at the memory system.

In some examples, the information component 540 may be configured as or otherwise support a means for receiving, in association with the indication of the cryptographic operation, a set of information used to generate the cryptographic key. In some examples, the set of information includes a password, a nonce, metadata, other data, or any combination thereof, associated with the cryptographic key.

In some examples, the indication component 525 may be configured as or otherwise support a means for receiving, in association with the indication of the cryptographic operation, an indication to store the cryptographic key at the memory system, where the indication of the result of the cryptographic operation includes an indication that the cryptographic key has been generated. In some examples, the indication component 525 may be configured as or otherwise support a means for receiving, in association with the indication of the cryptographic operation, an indication to output the cryptographic key, where the indication of the result of the cryptographic operation includes an indication of the cryptographic key. In some examples, the cryptographic key is a symmetric key including a randomly generated number. In some examples, the cryptographic key is an asymmetric key including a nonce.

In some examples, to support performing the cryptographic operation, the cryptographic operation component 530 may be configured as or otherwise support a means for encrypting a set of data using the one or more cryptographic primitives at the memory system. In some examples, the cryptographic operation component 530 may be configured as or otherwise support a means for storing the set of encrypted data at the memory system, where the indication of the result of the cryptographic operation includes an indication that the set of data has been encrypted. In some examples, to support outputting the indication of the result of the cryptographic operation, the result component 535 may be configured as or otherwise support a means for outputting, from the memory system, the set of encrypted data.

In some examples, the indication of the cryptographic operation is not associated with any access command for memory cells of the memory system. In some examples, the indication of a cryptographic operation is received via a bus that is also operable for receiving access commands, data, or both for memory cells of the memory system. In some examples, the indication of a cryptographic operation is received via a bus that is not operable for receiving access commands for memory cells of the memory system.

FIG. 6 shows a flowchart illustrating a method 600 that supports performing cryptographic functions at a memory system in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving, at a memory system, an indication of a cryptographic operation to perform at the memory system. The operations of 605 may be performed in accordance with examples as disclosed herein. In some examples, aspects of the operations of 605 may be performed by an indication component 525 as described with reference to FIG. 5.

At 610, the method may include performing, based on receiving the indication of the cryptographic operation, the cryptographic operation using one or more cryptographic primitives at the memory system. The operations of 610 may be performed in accordance with examples as disclosed herein. In some examples, aspects of the operations of 610 may be performed by a cryptographic operation component 530 as described with reference to FIG. 5.

At 615, the method may include outputting, from the memory system, an indication of a result of the cryptographic operation based on performing the cryptographic operation using the one or more cryptographic primitives at the memory system. The operations of 615 may be performed in accordance with examples as disclosed herein. In some examples, aspects of the operations of 615 may be performed by a result component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at a memory system, an indication of a cryptographic operation to perform at the memory system; performing, based on receiving the indication of the cryptographic operation, the cryptographic operation using one or more cryptographic primitives at the memory system; and outputting, from the memory system, an indication of a result of the cryptographic operation based on performing the cryptographic operation using the one or more cryptographic primitives at the memory system.

Aspect 2: The method, apparatus, or non-transitory computer-readable medium of aspect 1, where operations, features, circuitry, logic, means, or instructions, or any combination thereof for performing the cryptographic operation includes operations, features, circuitry, logic, means, or instructions, or any combination thereof for generating, using the one or more cryptographic primitives at the memory system, a digest value using a set of information, where the indication of the result of the cryptographic operation includes an indication of the digest value.

Aspect 3: The method, apparatus, or non-transitory computer-readable medium of any of aspects 1 through 2, further including operations, features, circuitry, logic, means, or instructions, or any combination thereof for receiving, in association with the indication of the cryptographic operation, a first subset of the set of information used to generate the digest value.

Aspect 4: The method, apparatus, or non-transitory computer-readable medium of any of aspects 1 through 3, where a second subset of the set of information includes data stored at the memory system prior to the indication of the cryptographic operation being received.

Aspect 5: The method, apparatus, or non-transitory computer-readable medium of any of aspects 1 through 4, where the first subset of the set of information includes metadata associated with the second subset of the set of information.

Aspect 6: The method, apparatus, or non-transitory computer-readable medium of any of aspects 1 through 4, where the first subset of the set of information includes input data for the one or more cryptographic primitives.

Aspect 7: The method, apparatus, or non-transitory computer-readable medium of any of aspects 1 through 6, where the set of information includes data stored at the memory system prior to the indication of the cryptographic operation being received.

Aspect 8: The method, apparatus, or non-transitory computer-readable medium of aspect 1, where operations, features, circuitry, logic, means, or instructions, or any combination thereof for performing the cryptographic operation includes operations, features, circuitry, logic, means, or instructions, or any combination thereof for generating, using the one or more cryptographic primitives at the memory system, an authentication code using a set of information and a cryptographic key.

Aspect 9: The method, apparatus, or non-transitory computer-readable medium of any of aspects 1 or 8, further including operations, features, circuitry, logic, means, or instructions, or any combination thereof for receiving, in association with the indication of the cryptographic operation, a first subset of the set of information used to generate the authentication code.

Aspect 10: The method, apparatus, or non-transitory computer-readable medium of any of aspects 1 or 8 through 9, where a second subset of the set of information includes data stored at the memory system prior to the indication of the cryptographic operation being received.

Aspect 11: The method, apparatus, or non-transitory computer-readable medium of any of aspects 1 or 8 through 10, where the first subset of the set of information includes metadata associated with the second subset of the set of information.

Aspect 12: The method, apparatus, or non-transitory computer-readable medium of any of aspects 1 or 8 through 10, where the first subset of the set of information includes input data for the one or more cryptographic primitives.

Aspect 13: The method, apparatus, or non-transitory computer-readable medium of any of aspects 1 or 8 through 12, where the set of information includes data stored at the memory system prior to the indication of the cryptographic operation being received.

Aspect 14: The method, apparatus, or non-transitory computer-readable medium of any of aspects 1 or 8 through 13, further including operations, features, circuitry, logic, means, or instructions, or any combination thereof for receiving, at the memory system, an indication of the cryptographic key, where generating the authentication code is based at least in part receiving the indication of the cryptographic key.

Aspect 15: The method, apparatus, or non-transitory computer-readable medium of any of aspects 1 or 8 through 14, further including operations, features, circuitry, logic, means, or instructions, or any combination thereof for identifying, at the memory system, the cryptographic key based on information stored at the memory system, information received by the memory system, or both.

Aspect 16: The method, apparatus, or non-transitory computer-readable medium of any of aspects 1 or 8 through 15, where operations, features, circuitry, logic, means, or instructions, or any combination thereof for outputting the indication of the result of the cryptographic operation include operations, features, circuitry, logic, means, or instructions, or any combination thereof for outputting the authentication code from the memory system.

Aspect 17: The method, apparatus, or non-transitory computer-readable medium of any of aspects 1 or 8 through 16, where operations, features, circuitry, logic, means, or instructions, or any combination thereof for outputting the indication of the result of the cryptographic operation include operations, features, circuitry, logic, means, or instructions, or any combination thereof for outputting an indication of whether the authentication code is verified.

Aspect 18: The method, apparatus, or non-transitory computer-readable medium of any of aspects 1 or 8 through 17, where the cryptographic key is a symmetric key or an asymmetric key.

Aspect 19: The method, apparatus, or non-transitory computer-readable medium of aspect 1, where operations, features, circuitry, logic, means, or instructions, or any combination thereof for performing the cryptographic operation includes operations, features, circuitry, logic, means, or instructions, or any combination thereof for generating a cryptographic key using the one or more cryptographic primitives at the memory system.

Aspect 20: The method, apparatus, or non-transitory computer-readable medium of any of aspects 1 or 19, further including operations, features, circuitry, logic, means, or instructions, or any combination thereof for receiving, in association with the indication of the cryptographic operation, a set of information used to generate the cryptographic key.

Aspect 21: The method, apparatus, or non-transitory computer-readable medium of any of aspects 1 or 19 through 20, where the set of information includes a password, a nonce, metadata, other data, or any combination thereof, associated with the cryptographic key.

Aspect 22: The method, apparatus, or non-transitory computer-readable medium of any of aspects 1 or 19 through 21, further including operations, features, circuitry, logic, means, or instructions, or any combination thereof for receiving, in association with the indication of the cryptographic operation, an indication to store the cryptographic key at the memory system, where the indication of the result of the cryptographic operation includes an indication that the cryptographic key has been generated.

Aspect 23: The method, apparatus, or non-transitory computer-readable medium of any of aspects 1 or 19 through 22, further including operations, features, circuitry, logic, means, or instructions, or any combination thereof for receiving, in association with the indication of the cryptographic operation, an indication to output the cryptographic key, where the indication of the result of the cryptographic operation includes an indication of the cryptographic key.

Aspect 23: The method, apparatus, or non-transitory computer-readable medium of any of aspects 1 or 19 through 22, where the cryptographic key is a symmetric key including a randomly generated number, or the cryptographic key is an asymmetric key including a nonce.

Aspect 25: The method, apparatus, or non-transitory computer-readable medium of aspect 1, where operations, features, circuitry, logic, means, or instructions, or any combination thereof for performing the cryptographic operation includes operations, features, circuitry, logic, means, or instructions, or any combination thereof for encrypting a set of data using the one or more cryptographic primitives at the memory system.

Aspect 26: The method, apparatus, or non-transitory computer-readable medium of any of aspects 1 or 25, further including operations, features, circuitry, logic, means, or instructions, or any combination thereof for storing the set of encrypted data at the memory system, where the indication of the result of the cryptographic operation includes an indication that the set of data has been encrypted.

Aspect 27: The method, apparatus, or non-transitory computer-readable medium of any of aspects 1 or 25 through 26, where operations, features, circuitry, logic, means, or instructions, or any combination thereof for outputting the indication of the result of the cryptographic operation include operations, features, circuitry, logic, means, or instructions, or any combination thereof for outputting, from the memory system, the set of encrypted data.

Aspect 28: The method, apparatus, or non-transitory computer-readable medium of any of aspects 1 through 27, where the indication of the cryptographic operation is not associated with any access command for memory cells of the memory system.

Aspect 29: The method, apparatus, or non-transitory computer-readable medium of any of aspects 1 through 28, where the indication of a cryptographic operation is received via a bus that is also operable for receiving access commands, data, or both for memory cells of the memory system.

Aspect 30: The method, apparatus, or non-transitory computer-readable medium of any of aspects 1 through 28, where the indication of a cryptographic operation is received via a bus that is not operable for receiving access commands for memory cells of the memory system.

It should be noted that the methods described above describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally or alternatively (e.g., in an alternative example) be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory system; and
a controller of the memory system, the controller configured to cause the apparatus to:
receive, at the memory system, an indication of a cryptographic operation to perform at the memory system;
perform, based at least in part on receiving the indication of the cryptographic operation, the cryptographic operation using one or more cryptographic primitives at the memory system; and
output, from the memory system, an indication of a result of the cryptographic operation based at least in part on performing the cryptographic operation using the one or more cryptographic primitives at the memory system.

2. The apparatus of claim 1, wherein, to perform the cryptographic operation, the controller is configured to cause the apparatus to:
generate, using the one or more cryptographic primitives at the memory system, a digest value using a set of information, wherein the indication of the result of the cryptographic operation comprises an indication of the digest value.

3. The apparatus of claim 2, wherein the controller is further configured to cause the apparatus to:
receive, in association with the indication of the cryptographic operation, a first subset of the set of information used to generate the digest value.

4. The apparatus of claim 3, wherein a second subset of the set of information comprises data stored at the memory system prior to the indication of the cryptographic operation being received.

5. The apparatus of claim 3, wherein the first subset of the set of information comprises input data for the one or more cryptographic primitives.

6. The apparatus of claim 2, wherein the set of information comprises data stored at the memory system prior to the indication of the cryptographic operation being received.

7. The apparatus of claim 1, wherein, to perform the cryptographic operation, the controller is configured to cause the apparatus to:
generate, using the one or more cryptographic primitives at the memory system, an authentication code using a set of information and a cryptographic key.

8. The apparatus of claim 7, wherein the controller is further configured to cause the apparatus to:
receive, in association with the indication of the cryptographic operation, a first subset of the set of information used to generate the authentication code.

9. The apparatus of claim 8, wherein a second subset of the set of information comprises data stored at the memory system prior to the indication of the cryptographic operation being received.

10. The apparatus of claim 8, wherein the first subset of the set of information comprises input data for the one or more cryptographic primitives.

11. The apparatus of claim 7, wherein the set of information comprises data stored at the memory system prior to the indication of the cryptographic operation being received.

12. The apparatus of claim 7, wherein, to output the indication of the result of the cryptographic operation, the controller is configured to cause the apparatus to:
output the authentication code from the memory system.

13. The apparatus of claim 7, wherein, to output the indication of the result of the cryptographic operation, the controller is configured to cause the apparatus to:
output an indication of whether the authentication code is verified.

14. The apparatus of claim 1, wherein, to perform the cryptographic operation, the controller is configured to cause the apparatus to:
generate a cryptographic key using the one or more cryptographic primitives at the memory system.

15. The apparatus of claim 14, wherein the controller is further configured to cause the apparatus to:
receive, in association with the indication of the cryptographic operation, a set of information used to generate the cryptographic key.

16. The apparatus of claim 1, wherein, to perform the cryptographic operation, the controller is further configured to cause the apparatus to:
encrypt a set of data using the one or more cryptographic primitives at the memory system.

17. The apparatus of claim 16, wherein the controller is further configured to cause the apparatus to:
store the set of encrypted data at the memory system, wherein the indication of the result of the cryptographic operation comprises an indication that the set of data has been encrypted.

18. The apparatus of claim 16, wherein, to output the indication of the result of the cryptographic operation, the controller is configured to cause the apparatus to:
output, from the memory system, the set of encrypted data.

19. A non-transitory computer-readable medium storing code comprising instructions which, when executed by a processor of an electronic device, cause the electronic device to:
receive, at a memory system, an indication of a cryptographic operation to perform at the memory system;
perform, based at least in part on receiving the indication of the cryptographic operation, the cryptographic operation using one or more cryptographic primitives at the memory system; and
output, from the memory system, an indication of a result of the cryptographic operation based at least in part on performing the cryptographic operation using the one or more cryptographic primitives at the memory system.

20. A method, comprising:
receiving, at a memory system, an indication of a cryptographic operation to perform at the memory system;
performing, based at least in part on receiving the indication of the cryptographic operation, the cryptographic operation using one or more cryptographic primitives at the memory system; and
outputting, from the memory system, an indication of a result of the cryptographic operation based at least in part on performing the cryptographic operation using the one or more cryptographic primitives at the memory system.
